(19) United States
(12) Patent Application Publication
(10) Pub. No.: US 2003/0104888 A1
(43) Pub. Date: Jun. 5, 2003

(54) Drive belt tensioner

(76) Inventors: Gianluca Cariccia, Romano Canavese (IT); Graziano Di Ciano, Romano Canavese (IT)

Correspondence Address: BLANK ROME COMISKY & MCCAULEY LLP, THE FARRAGUT BUILDING, SUITE 1000, 900 17TH STREET, NW, WASHINGTON, DC, 20006, US

(21) Appl. No.: 10/170,416

(22) Filed: Jun. 14, 2002

(30) Foreign Application Priority Data
Jun. 15, 2001 (IT) TO2001A 000584

(51) Int. Cl. F16H 7/12

(52) U.S. Cl. 474/135

(57) ABSTRACT

A tensioner for a drive belt, having a fixed portion connected rigidly to a supporting structure; a movable portion hinged to the fixed portion about a first axis; a pulley carried by the movable portion and rotating, with respect to it, about a second axis distinct from and parallel to the first axis, a spring interposed between the fixed portion and the movable portion, and for loading, in use, the movable portion to keep the pulley engaged with the belt; and a damping member having a connecting portion fixed rigidly to the fixed portion, and a friction portion cooperating with a seat formed in the movable portion; the tensioner having a single screw for fixing the fixed portion to the supporting structure, and the damping member to the fixed portion.

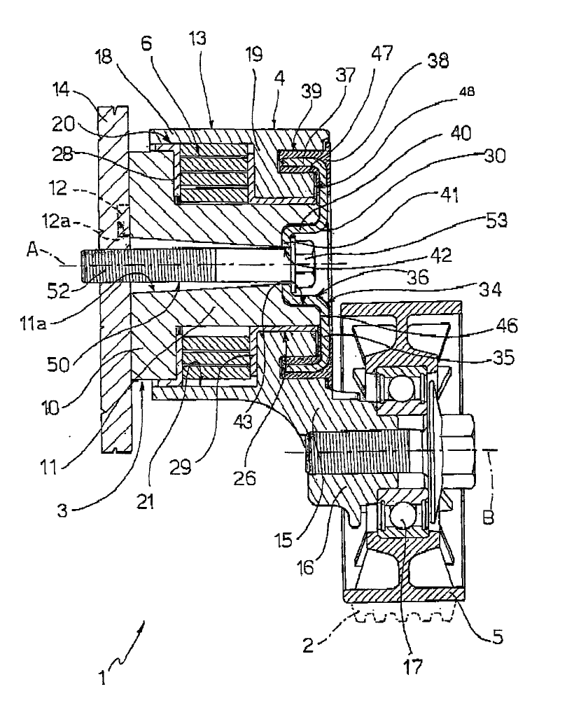

The present invention relates to a tensioner for a drive belt, particularly, though not exclusively, for a belt transmitting motion from the drive shaft of an internal combustion engine to auxiliary members powered by the engine.

### BACKGROUND OF THE INVENTION

Tensioners are known comprising a fixed portion connected rigidly to the engine or to a supporting structure integral with the engine; a movable portion hinged to the fixed portion about a first axis; a pulley carried by the movable portion and rotating, with respect to it, about a second axis distinct from and parallel to the first axis; and a spring interposed between the fixed and movable portions, and which loads the movable portion to keep the pulley engaged with the belt.

Any variation in the tension of the belt, caused by selective operation of the various accessories or by wear, is therefore compensated by a variation in deformation of the spring and by a corresponding shift in the axis of rotation of the pulley.

Since the belt transmits a pulsating load to the pulley, to limit oscillation and prevent resonance phenomena, damping means are normally provided between the fixed portion and the movable portion.

In one known embodiment described in U.S. Pat. No. 5,993,340, the damping means comprise a damping member having a connecting portion fixed rigidly to the fixed portion, and an annular friction portion extending axially from the connecting portion and cooperating with a seat formed in the movable portion.

### SUMMARY OF THE INVENTION

It is an object of the present invention to provide a simplified tensioner of the type briefly described above, which can be produced and assembled as quickly and cheaply as possible.

According to the present invention, there is provided a tensioner for a drive belt, of the type comprising a fixed portion; first connecting means for connecting said fixed portion rigidly to a supporting structure; a movable portion hinged to said fixed portion about a first axis; a pulley carried by said movable portion and rotating, with respect to it, about a second axis distinct from and parallel to said first axis; elastic means interposed between said fixed portion and said movable portion, and for loading, in use, said movable portion to keep said pulley engaged with said belt; a friction damping member interposed between said fixed portion and said movable portion, and having a connecting portion fixed to said fixed portion, and a friction portion cooperating with said movable portion; and second connecting means for fixing said connecting portion to said fixed portion; characterized in that said first and second connecting means are defined by a single connecting member.

### BRIEF DESCRIPTION OF THE DRAWING

A preferred, non-limiting embodiment of the present invention will be described by way of example with reference to the accompanying drawing showing an axial section.

### DETAILED DESCRIPTION OF THE INVENTION

Number 1 in the accompanying drawing indicates as a whole a tensioner for a poly-V belt 2 powering the auxiliary members (not shown) of an internal combustion engine (not shown).

Tensioner 1 substantially comprises, in known manner, a fixed portion 3 connected rigidly to a supporting structure 14 defined, for example, by a plate supporting the auxiliary members and fixed to the crankcase of the engine, or by the crankcase itself; a movable portion 4 hinged to fixed portion 3 about a first axis A; a pulley 5 projecting from movable portion 4 and rotating, with respect to it, about a second axis B distinct from and parallel to first axis A; and a spring 6 interposed between fixed portion 3 and movable portion 4, and which loads the movable portion to keep pulley 5 engaged with belt 2.

More specifically, fixed portion 3 comprises, integrally, a flange 10 cooperating axially with supporting structure 14, and a tubular pin 11, of axis A, projecting axially from flange 10 and having a conical axial cavity 11a flaring towards flange 10. Flange 10 has a number of face teeth 12 engaging respective seats 12a in supporting structure 14 secure fixed portion 3 angularly.

Movable portion 4 comprises, integrally, a hub 13 coaxial with and fitted in rotary manner to pin 11; an arm 15 projecting radially from hub 13; and a tubular portion 16, of axis B, connected integrally to one end of arm 15 to support pulley 5 by means of a bearing 17.

Hub 13 of movable portion 4 is substantially bell-shaped, and comprises a large-diameter first portion 18 and a small-diameter second portion 19 axially adjacent to each other.

Part of the axial length of first portion 18 surrounds flange 10, and is supported radially on flange by a bush 20 which, together with flange 10, defines a torque with a predetermined friction coefficient. The rest of the length of first portion 18 defines, with pin 11, an annular chamber 21 housing spring 6, which is defined by a steel strip coiled about pin 11 and having an inner end (not shown) connected in known manner to pin 11, and an outer end (not shown) connected in known manner to portion 18.

Second portion 19 is supported radially on pin 11 with the interposition of a bush 26 defining, with pin 11, a torque with a predetermined friction coefficient.

Bush 20 and bush 26 have, respectively, a flat annular inner end flange 28 and a flat annular outer end flange 29, which cooperate axially with opposite sides of spring 6 and are interposed respectively, between spring 6 and flange 10, and between spring 6 and second portion 19 of hub 13.

Tensioner 1 also comprises a damping member 30 interposed between pin 11 and movable portion 4.

Damping member 30 comprises an annular metal core 34 having a flat annular base wall 15, a substantially cylindrical central portion 36 extending axially from an inner edge of base wall 35, and a substantially cylindrical lateral wall 37 projecting from an outer periphery of base wall 35 and coaxial with central portion 36.

Damping member 30 also comprises a cover 38 made of plastic material and extending on a peripheral portion of base wall 35 and on the entire surface of lateral wall 37, so as to form, with lateral wall 37, an annular friction ring 39.

Central portion 36 comprises a cylindrical lateral wall 40; and a flat end wall 41 perpendicular to axis A and having an axial through hole 42.

Damping member 30 is fitted to fixed portion 3 so than central portion 36 is housed inside a cylindrical axial seat 43 formed in one end 46 of pin 11, and so that friction ring 39 engages a complementary annular seat 47 formed in an end face 48 of portion 19 of hub 13. The material of covering 38 is selected to define, with hub 13, a torque with a predetermined friction coefficient, and ensure adequate oscillation-damping properties in use. Friction ring 39 and seat 47 conveniently contact along both the inner and outer cylindrical surfaces of the ring.

According to the present invention, tensioner 1 comprises a single fastening member for fastening fixed portion 3 of the tensioner to supporting structure 14, and damping member 30 to fixed portion 3. The fastening member is conveniently defined by an axial screw 50 comprising a shank 52 fitted through hole 42 in central portion 36 of core 34, and through inner cavity 11a of pin 11, and which screws into supporting structure 14; and a head 53 housed in central portion 36 of the core and which grips core 34 to pin 11.

Operation of tensioner 1 is known and therefore not described in detail.

Oscillation of movable portion 4 with respect to fixed portion 3, in response to dynamic pulsating variations in the pull of belt 2, are damped by bushes 20 and 26 and by damping member 30.

According to the present invention, tensioner 1 is extremely cheap to produce and can be assembled quickly and easily, by screw 50 fastening tensioner 1 to supporting structure 14, and also fastening damping member 30 to fixed portion 3 of tensioner 1.

Clearly, changes may be made to tensioner 1 as described herein without, however, departing from the scope of the present invention.

1) A tensioner (1) for a drive belt (2), of the type comprising a fixed portion (3); first connecting means (50) for connecting said fixed portion (3) rigidly to a supporting structure (14); a movable portion (4) hinged to said fixed portion (3) about a first axis (A); a pulley (5) carried by said movable portion (4) and rotating, with respect to it, about a second axis (B) distinct from and parallel to said first axis (A); elastic means (6) interposed between said fixed portion (3) and said movable portion (4), and for loading, in use, said movable portion (4) to keep said pulley (5) engaged with said belt (2); a friction damping member (30) interposed between said fixed portion (3) and said movable portion (4), and having a connecting portion (36) fixed to said fixed portion (3), and a friction portion (39) cooperating with said movable portion (4); and second connecting means (50) for fixing said connecting portion (36) to said fixed portion (3); characterized in that said first and second connecting means are defined by a single connecting member (50).

2) A tensioner as claimed in claim 1, characterized in that said fixed portion comprises a flange cooperating with said supporting structure, and a tubular pin (11) defining said first axis (A); said connecting member being defined by a screw (50) comprising a shank fitted through said pin (11) and through said connecting portion (36) of said damping member (30), and a head (52) for gripping said connecting portion (36) to one end (46) of said pin (11).

3) A tensioner as claimed in claim 2, characterized in that said connecting portion (36) is substantially cylindrical, houses said head (52) of said screw (50), and is housed in a correspondingly shaped seat (43) formed in said end (46) of said pin (11).

4) A tensioner as claimed in claim 1, characterized in that said movable portion (4) comprises a hub (13) fitted in rotary manner to said pin (11); and in that said friction portion (39) of said damping member (30) is defined by a ring externally coaxial with said connecting portion (36) and engaging a corresponding annular seat (47) formed on an end face (49) of said hub (13).

5) A tensioner as claimed in claim 4, characterized in that said damping member (30) comprises a metal core (34); and a friction cover (38) extending at least on said friction portion (39).
